(19) United States
(12) Patent Application Publication
(10) Pub. No.: US 2005/0141955 A1
(43) Pub. Date: Jun. 30, 2005

(54) Towing hitch for connecting a trailer to a wheeled vehicle

(76) Inventor: Vincent Chang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/746,752

(22) Filed: Dec. 24, 2003

(51) Int. Cl. F16D 1/12

(52) U.S. Cl. 403/128

(57) ABSTRACT

A towing hitch includes a fixing bar, a fixing ball, and a stepped seat. The towing hitch is used for connecting a trailer to a wheeled vehicle, such as a car or the like. Thus, the fixing bar is formed with a mounting shaft for detachably mounting the fixing ball or the fixing bar, so that the towing hitch has a detachable structure, thereby facilitating assembly of the towing hitch, and thereby decreasing costs of fabrication.

### BACKGROUND OF THE INVENTION

1. Field of the Invention

The present invention relates to a towing hitch, and more particularly to a towing hitch for connecting a trailer to a wheeled vehicle, such as a car or the like.

2. Description of the Related Art

A conventional towing hitch 1 in accordance with the prior art shown in FIGS. 13 and 14 is used for connecting a towing bar 3 of a trailer 2 to a towing bar 5 of a wheeled vehicle 4 (such as a car or the like). As shown in FIG. 14, the conventional towing hitch 1 comprises a fixing bar 11 having a first end formed with a threaded face 13 for screwing a nut 14 and a washer 15, a mediate portion integrally formed with a stepped seat 12, and a second end integrally formed with a fixing ball 16. A mounting space 18 is formed between the washer 15 and the stepped seat 12, so that the conventional towing hitch 1 can be mounted on the towing bar 3 of the trailer 2. The fixing ball 16 is directed upward to mount a bushing (not shown) of the towing bar 5 of the wheeled vehicle 4 to form a joint structure.

However, the fixing bar 11 is integrally formed with the threaded face 13, the stepped seat 12 and the fixing ball 16, so that it is necessary to work and align the fixing bar 11, the threaded face 13, the stepped seat 12 and the fixing ball 16, thereby greatly increasing difficulty of the working process, and thereby increasing costs of fabrication.

### SUMMARY OF THE INVENTION

The primary objective of the present invention is to provide a towing hitch for connecting a trailer to a wheeled vehicle, such as a car or the like.

Another objective of the present invention is to provide a towing hitch, wherein the fixing bar is formed with a mounting shaft for detachably mounting the fixing ball or the fixing bar, so that the towing hitch has a detachable structure, thereby facilitating assembly of the towing hitch, and thereby decreasing costs of fabrication.

A further objective of the present invention is to provide a towing hitch, wherein the mounting hole of the fixing ball is exactly aligned with the mounting shaft of the fixing bar, so that the fixing ball is mounted on the fixing bar easily and conveniently.

A further objective of the present invention is to provide a towing hitch, wherein the abutment of the fixing ball is closely rested on the stepped seat of the fixing bar, so that the fixing ball is integrally combined with the fixing bar rigidly and stably.

In accordance with one embodiment of the present invention, there is provided a towing hitch, comprising a fixing bar, and a fixing ball, wherein:
the fixing bar has a first end formed with a threaded face for screwing a nut and a washer, a mediate portion integrally formed with a stepped seat, and a second end formed with a threaded rod and a mounting shaft; and
the fixing ball is detachably mounted on the fixing bar and has a first end formed with a mounting hole mounted on the mounting shaft of the fixing bar and a second end formed with a screw bore screwed on the threaded rod of the fixing bar.

In accordance with another embodiment of the present invention, there is provided a towing hitch, comprising a fixing bar, a fixing ball, and a stepped seat, wherein:
the fixing bar has a first end formed with a threaded face for screwing a nut and a washer and a second end formed with a mounting shaft;
the fixing ball is integrally formed on the second end of the fixing bar and has an end having a periphery formed with an abutment; and
the stepped seat is detachably mounted on the second end of the fixing bar and has an inside formed with a mounting hole mounted on the mounting shaft of the fixing bar.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a towing hitch in accordance with the preferred embodiment of the present invention;

FIG. 2 is a plan cross-sectional view of a fixing ball of the towing hitch as shown in FIG. 1;

FIG. 3 is an exploded perspective view of a towing hitch in accordance with another embodiment of the present invention;

FIG. 4 is a plan cross-sectional view of a fixing ball of the towing hitch as shown in FIG. 3;

FIG. 5 is an exploded perspective view of a towing hitch in accordance with another embodiment of the present invention;

FIG. 6 is an exploded perspective view of a towing hitch in accordance with another embodiment of the present invention;

FIG. 7 is an exploded perspective view of a towing hitch in accordance with another embodiment of the present invention;

FIG. 8 is an exploded perspective view of a towing hitch in accordance with another embodiment of the present invention;

FIG. 9 is an exploded perspective view of a towing hitch in accordance with another embodiment of the present invention;

FIG. 10 is a partially plan cross-sectional assembly view of the towing hitch as shown in FIG. 9;

FIG. 11 is an exploded perspective view of a towing hitch in accordance with another embodiment of the present invention; and

FIG. 12 is a partially plan cross-sectional assembly view of the towing hitch as shown in FIG. 11;

FIG. 13 is a schematic plan view of a conventional towing hitch for connecting a trailer to a wheeled vehicle in accordance with the prior art; and

FIG. 14 is a perspective view of the conventional towing hitch in accordance with the prior art.

### DETAILED DESCRIPTION OF THE INVENTION

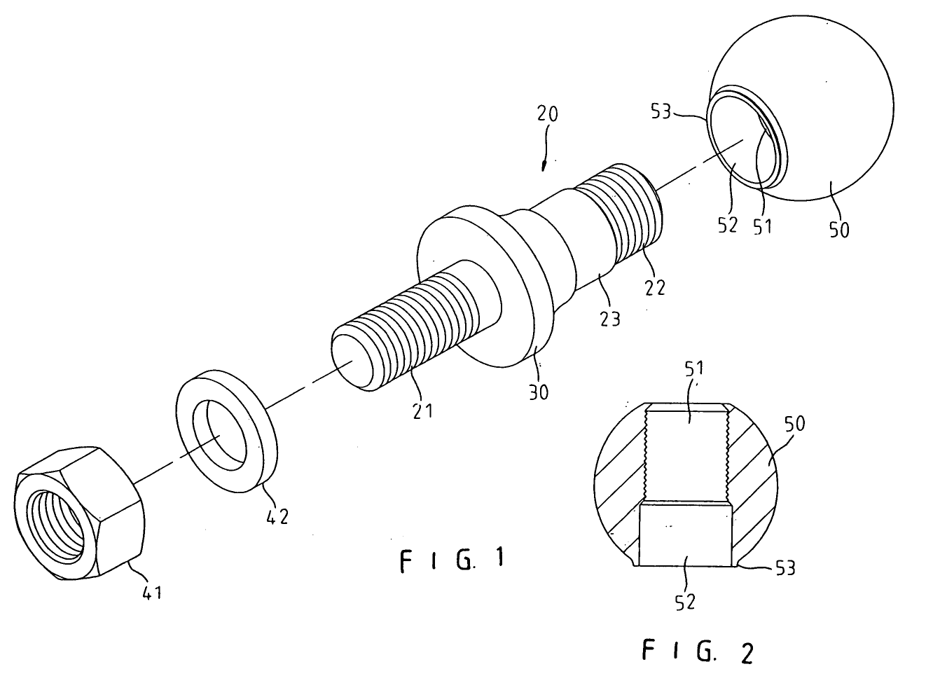

Referring to the drawings and initially to FIGS. 1 and 2, a towing hitch in accordance with the preferred embodiment of the present invention is used for connecting a trailer (not shown) to a wheeled vehicle (not shown), such as a car or the like.

The towing hitch comprises a fixing bar 20, and a fixing ball 50.

The fixing bar 20 has a first end formed with a threaded face 21 for screwing a nut 41 and a washer 42, a mediate portion integrally formed with a stepped seat 30 having a larger diameter, and a second end formed with a threaded rod 22 and a mounting shaft 23 located between the stepped seat 30 and the threaded rod 22. A mounting space (not shown) is formed between the washer 42 and the stepped seat 30. The mounting shaft 23 has a diameter greater than that of the threaded rod 22.

The fixing ball 50 is detachably mounted on the fixing bar 20 and has a first end formed with a mounting hole 52 mounted on the mounting shaft 23 of the fixing bar 20 and a second end formed with a screw bore 51 screwed on the threaded rod 22 of the fixing bar 20. Preferably, the second end of the fixing ball 50 has an open side and the screw bore 51 of the fixing ball 50 is extended through a whole length of the second end of the fixing ball 50 as shown in FIG. 2. In addition, the first end of the fixing ball 50 has a periphery formed with an annular abutment 53 rested on the stepped seat 30 of the fixing bar 20.

Thus, the mounting hole 52 of the fixing ball 50 is exactly aligned with the mounting shaft 23 of the fixing bar 20, so that the fixing ball 50 is mounted on the fixing bar 20 easily and conveniently. In addition, the abutment 53 of the fixing ball 50 is closely rested on the stepped seat 30 of the fixing bar 20, so that the fixing ball 50 is integrally combined with the fixing bar 20 rigidly and stably.

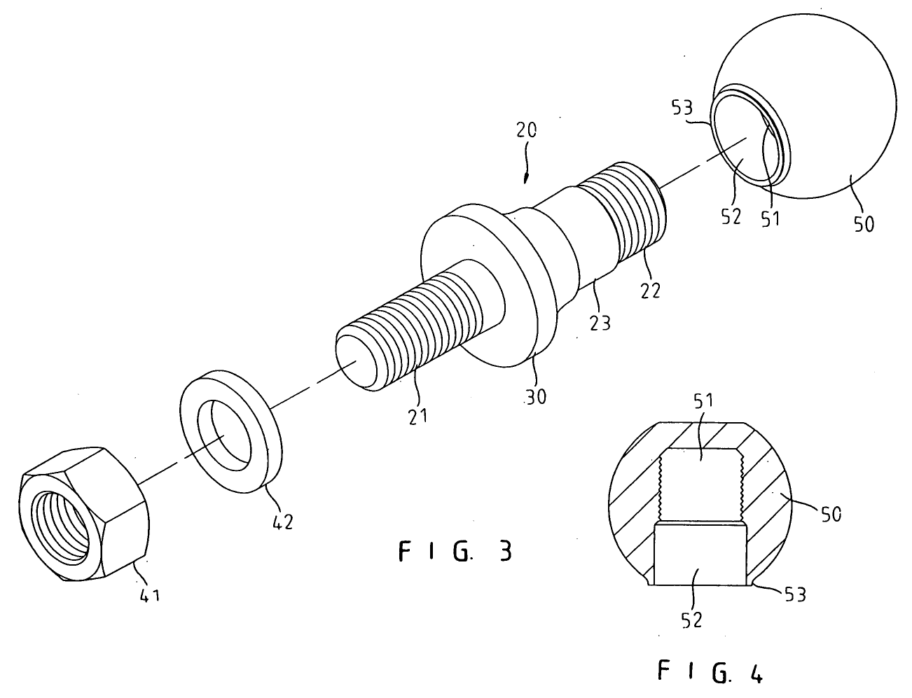

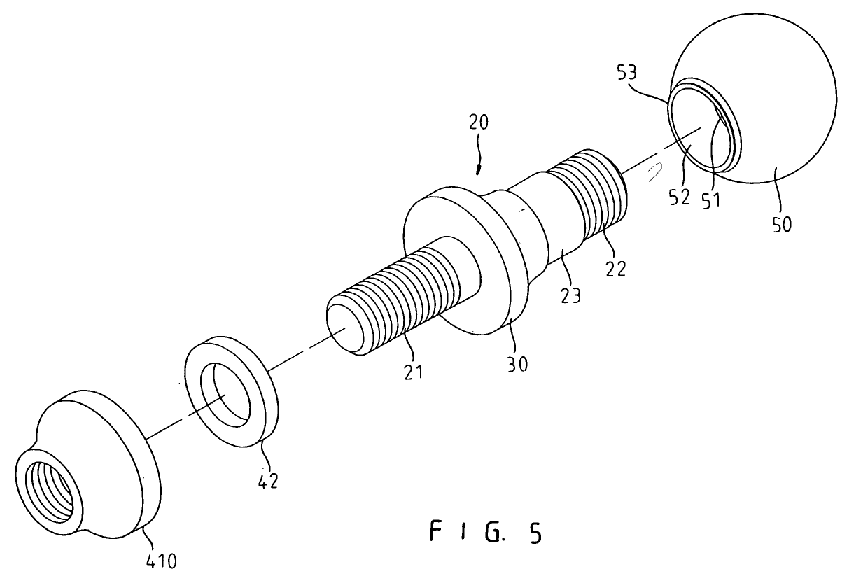

Referring to FIGS. 3 and 4, the second end of the fixing ball 50 has a closed side and the screw bore 51 of the fixing ball 50 is not extended through the whole length of the second end of the fixing ball 50.

Referring to FIG. 5, the nut 410 has another shape.

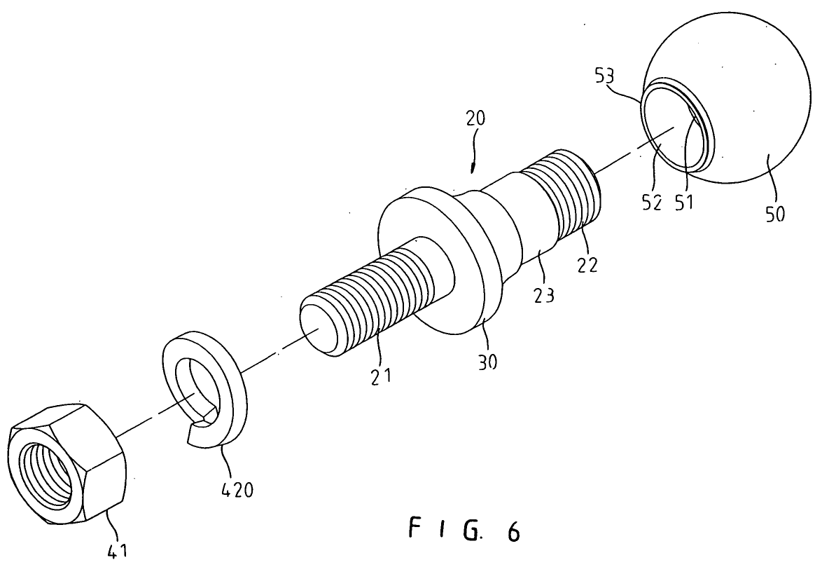

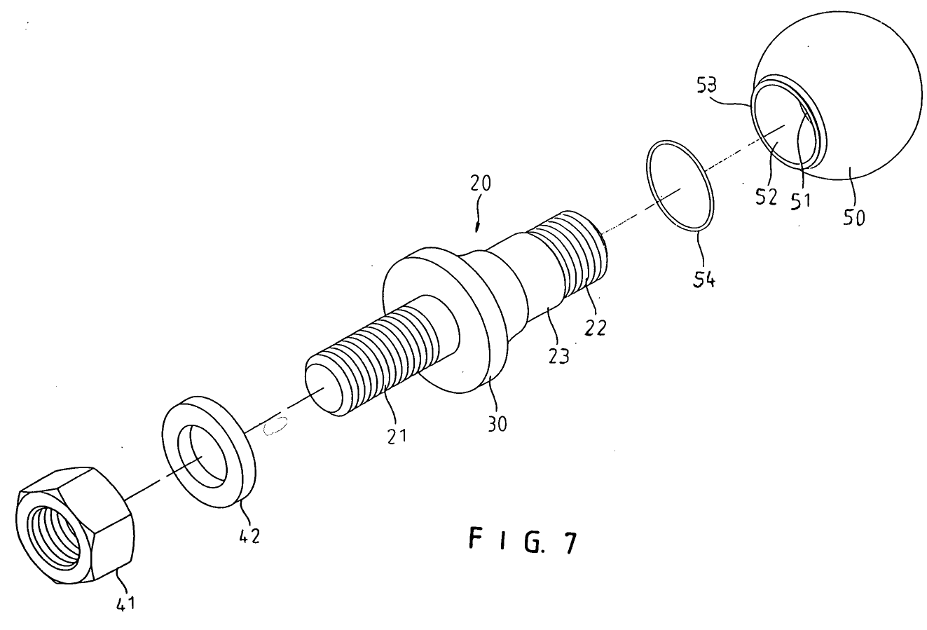

Referring to FIG. 6, the washer 420 is a substantially C-shaped elastic washer.

Referring to FIG. 7, the towing hitch further comprises an O-ring 54 mounted on the fixing bar 20 and clamped between the stepped seat 30 of the fixing bar 20 and the abutment 53 of the fixing ball 50 to provide a buffer effect.

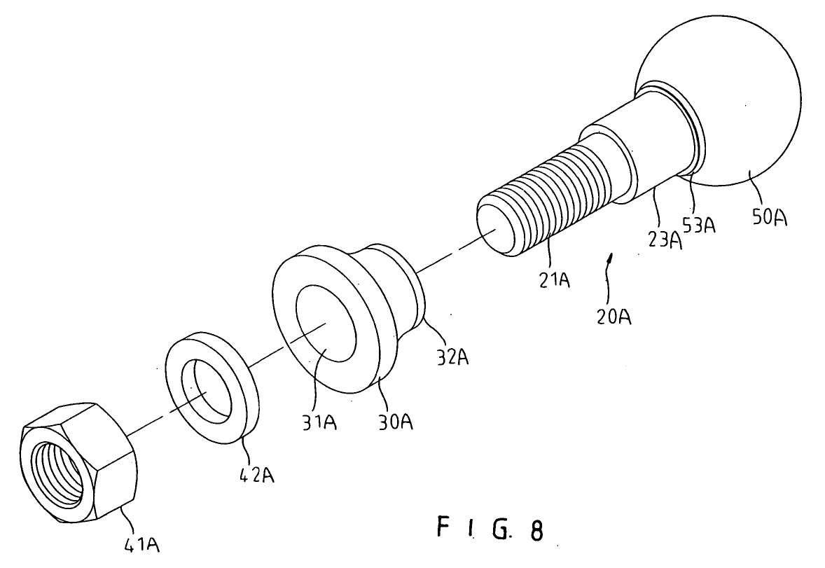

Referring to FIG. 8, a towing hitch in accordance with another embodiment of the present invention comprises a fixing bar 20A, a fixing ball 50A, and a stepped seat 30A.

The fixing bar 20A has a first end formed with a threaded face 21A for screwing a nut 41A and a washer 42A and a second end formed with a mounting shaft 23A. The mounting shaft 23A has a diameter greater than that of the threaded face 21A.

The fixing ball 50A is integrally formed on the second end of the fixing bar 20A and has an end having a periphery formed with an abutment 53A located adjacent to an end of the mounting shaft 23A of the fixing bar 20A. Preferably, the mounting shaft 23A of the fixing bar 20A is located between the threaded face 21 A of the fixing bar 20A and the fixing ball 50A.

The stepped seat 30A is detachably mounted on the second end of the fixing bar 20A and has an inside formed with a mounting hole 31A mounted on the mounting shaft 23A of the fixing bar 20A. The stepped seat 30A has an end having a periphery formed with a lip 32A rested on the abutment 53A of the fixing ball 50A. A mounting space (not shown) is formed between the washer 42A and the stepped seat 30A.

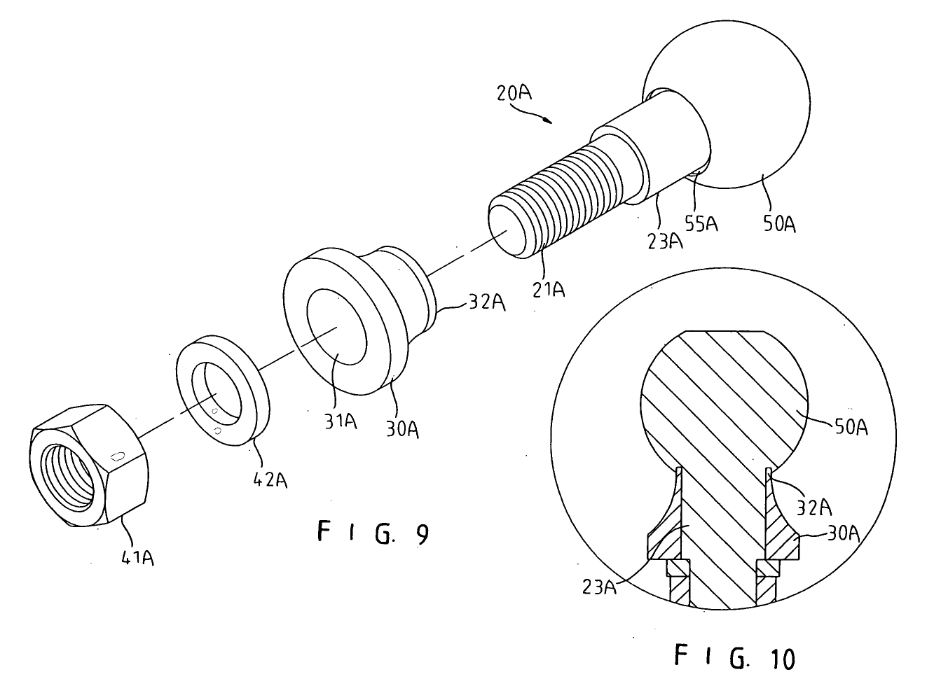

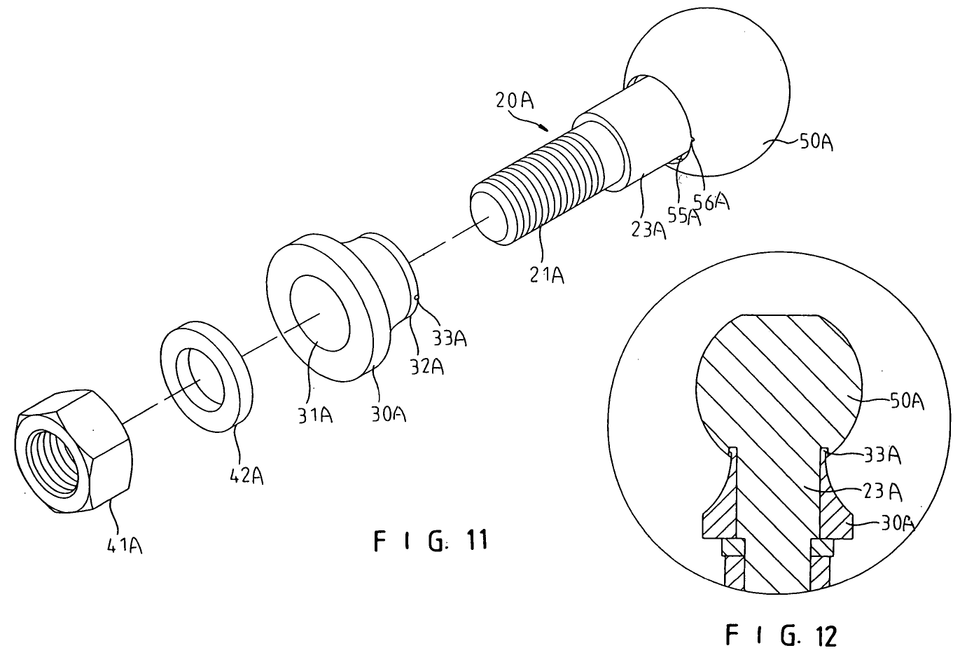

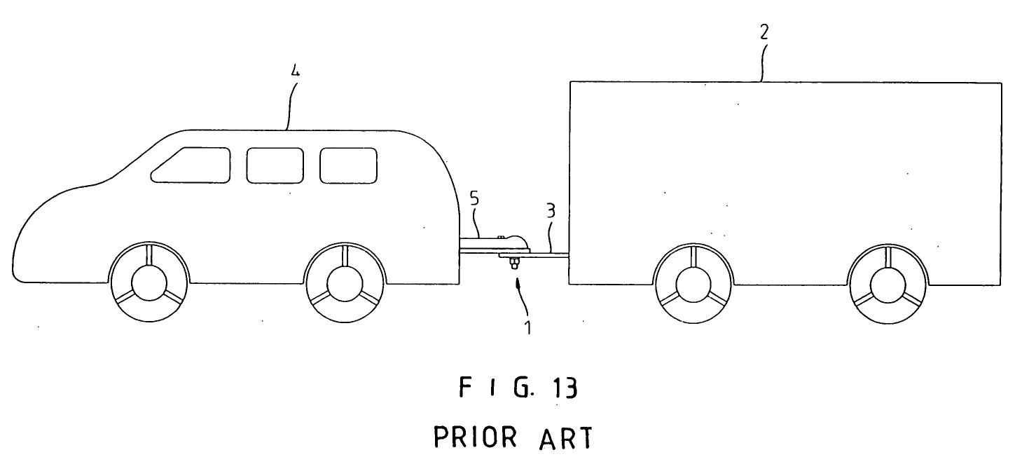

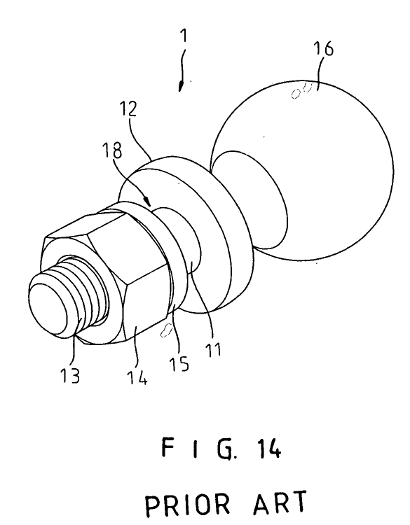

Referring to FIGS. 9 and 10, the fixing ball 50A has an end having a periphery formed with a positioning groove 55A located adjacent to an end of the mounting shaft 23A of the fixing bar 20A, and the stepped seat 30A has an end having a periphery formed with a lip 32A inserted into the positioning groove 55A of the fixing ball 50A.

Referring to FIGS. 11 and 12, the positioning groove 55A of the fixing ball 50A has a periphery formed with a locking hole 56A, and the lip 32A of the stepped seat 30A has a periphery formed with a locking stub 33A locked in the locking hole 56A of the fixing ball 50A.

Accordingly, the fixing bar is formed with a mounting shaft for detachably mounting the fixing ball or the fixing bar, so that the towing hitch has a detachable structure, thereby facilitating assembly of the towing hitch, and thereby decreasing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A towing hitch, comprising a fixing bar, and a fixing ball, wherein:
the fixing bar has a first end formed with a threaded face for screwing a nut and a washer, a mediate portion integrally formed with a stepped seat, and a second end formed with a threaded rod and a mounting shaft; and
the fixing ball is detachably mounted on the fixing bar and has a first end formed with a mounting hole mounted on the mounting shaft of the fixing bar and a second end formed with a screw bore screwed on the threaded rod of the fixing bar.

2. The towing hitch in accordance with claim 1, wherein the mounting shaft is located between the stepped seat and the threaded rod.

3. The towing hitch in accordance with claim 1, wherein the mounting shaft has a diameter greater than that of the threaded rod.

4. The towing hitch in accordance with claim 1, wherein the second end of the fixing ball has an open side and the screw bore of the fixing ball is extended through a whole length of the second end of the fixing ball.

5. The towing hitch in accordance with claim 1, wherein the first end of the fixing ball has a periphery formed with an annular abutment rested on the stepped seat of the fixing bar.

6. The towing hitch in accordance with claim 1, wherein the second end of the fixing ball has a closed side and the screw bore of the fixing ball is not extended through the whole length of the second end of the fixing ball.

7. The towing hitch in accordance with claim 1, wherein the washer is a substantially C-shaped elastic washer.

8. The towing hitch in accordance with claim 1, further comprising an O-ring mounted on the fixing bar and clamped between the stepped seat of the fixing bar and the abutment of the fixing ball to provide a buffer effect.

9. A towing hitch, comprising a fixing bar, a fixing ball, and a stepped seat, wherein:
the fixing bar has a first end formed with a threaded face for screwing a nut and a washer and a second end formed with a mounting shaft;
the fixing ball is integrally formed on the second end of the fixing bar and has an end having a periphery formed with an abutment; and
the stepped seat is detachably mounted on the second end of the fixing bar and has an inside formed with a mounting hole mounted on the mounting shaft of the fixing bar.

10. The towing hitch in accordance with claim 9, wherein the mounting shaft has a diameter greater than that of the threaded face.

11. The towing hitch in accordance with claim 9, wherein the fixing ball has an end having a periphery formed with an abutment, and the stepped seat has an end having a periphery formed with a lip rested on the abutment of the fixing ball.

12. The towing hitch in accordance with claim 11, wherein the abutment is located adjacent to an end of the mounting shaft of the fixing bar.

13. The towing hitch in accordance with claim 9, wherein the mounting shaft of the fixing bar is located between the threaded face of the fixing bar and the fixing ball.

14. The towing hitch in accordance with claim 9, wherein the fixing ball has an end having a periphery formed with a positioning groove located adjacent to an end of the mounting shaft of the fixing bar, and the stepped seat has an end having a periphery formed with a lip inserted into the positioning groove of the fixing ball.

15. The towing hitch in accordance with claim 14, wherein the positioning groove of the fixing ball has a periphery formed with a locking hole, and the lip of the stepped seat has a periphery formed with a locking stub locked in the locking hole of the fixing ball.
